(19) United States
(12) Patent Application Publication
(10) Pub. No.: US 2021/0342775 A1
(43) Pub. Date: Nov. 4, 2021

(54) SYSTEM, DEVICE AND METHOD FOR AUTOMATED PROOF OF DELIVERY IMAGE PROCESSING

(71) Applicant: Lasership, Inc., Vienna, VA (US)

(72) Inventors: Jon David Herberger, McLean, VA (US); Marc Lallier, Hilliard, OH (US); Shawn Lee Evans, Triangle, VA (US)

(21) Appl. No.: 16/865,758

(22) Filed: May 4, 2020

(51) Int. Cl. G06Q 10/08; G06K 9/00; G06K 9/32

(52) U.S. Cl. CPC G06Q 10/0833; G06K 9/3241; G06K 9/00671

(57) ABSTRACT

A system, device and method automate proof of delivery image processing. In embodiments, package proof of delivery images are received from workers' devices, the images are scanned and features are determined from the scanned images. Based on the determined feature, a classifier is determined for each of the plurality of images according to a classifier database.

### TECHNICAL FIELD

The present invention pertains to image processing, and more particularly to a system, device and method for processing proof of delivery images.

### BACKGROUND AND SUMMARY

Package delivery services are well known. Under certain conditions, delivery companies may offer or be contractually required to take a photograph of packages delivered to recipients, such as when leaving packages behind at the destination when the recipient is not present. Such photos are used for Proof of Delivery (POD) purposes and, in turn, the quality of these photos is important. However, due to a number of reasons, including, but not limited to, weather conditions and damaged or faulty equipment, a significant amount of bad quality images are collected.

Labeled POD images can be difficult to obtain and time-consuming to produce. Manual efforts at labeling POD images generally involve human inspection of images and application of a known label. For example, labels can be as shown in Table 1 below.

TABLE 1

| Number | Label | Description |
|---|---|---|
| 1 | GOODVPOD | Quality Good |
| 2 | LOWQLABL | Low Quality Barcode Label |
| 3 | LOWQCOMN | Low Quality Common Area Mismatch |
| 4 | LOWQFNCE | Low Quality Fence or Garage |
| 5 | LOWQPICE | Low Quality No Package in Image |
| 6 | LOWQOUTB | Low Quality Outside Building |
| 7 | LOWQMLBX | Low Quality Placement-Mailbox |
| 8 | LOWQDSTN | Low Quality Too Close or Far |

Certain physical aspects of a delivery location can be included in the label and/or description. For example, terms like garage, fence, mailbox and other terms denote physical aspects of various delivery locations and can be employed in the labeling process.

Alternative classifiers may be, for example, as shown in Table 2 below.

TABLE 2

| Number | Label | Description |
|---|---|---|
| 1 | LOWQNSFW | Unsafe for Work |
| 2 | GOODVPOD | Quality Good |
| 3 | LOWCAMMT | Low Quality Common Area Mismatch |
| 4 | LOWQFNCE | Low Quality Fence |
| 5 | LOWQGRGE | Low Quality Garage |
| 6 | LOWQMLBX | Low Quality Mailbox |
| 7 | LOWQNPCE | Low Quality Photo |
| 8 | LOWQOUTB | Low Quality Outside Building |
| 9 | LOWQPLCM | Low Quality Poor Placement |
| 10 | LOWQDSTN | Low Quality Too Close |

Since images of poor quality are generally not useful in electronic POD-related systems, it is desirable to obtain good quality images. It is also desirable to effectively label images so that good quality images can be utilized and lesser quality images can be categorized and processed accordingly. While human labeling of POD images exists, the use of human-labeled POD images does not assist in effectively automating POD labeling. Any human labeler generally only has the raw POD image itself when determining whether the image qualifies as a good virtual proof of delivery image (e.g., a “GOODVPOD” label) or a low-quality image, for example. While the labeler may also look at internal delivery data and drop location information, such information generally does not assist with labeling of the actual POD photograph. Importantly, no additional information regarding the delivery is considered in the human labeling approach.

The system, device and method of the present disclosure addresses and remedies these issues and assists in automating the labeling of POD images so as to facilitate usability in electronic delivery provider and delivery recipient systems.

Rather than conforming to existing labels for manual analysis, embodiments of the present system and method scan obtained images and group them into naturally occurring categories/classes based on what is actually contained within the images. Using this methodology, the system is not limited to predetermined classes, but may create literally hundreds of classes of delivery image labels. This is a significant improvement, in part, because it eliminates class overlap. Additionally, there is no risk of variation between human labelers. Further, the process is faster and more flexible to changes/edits in both the number of labels or classifiers, as well as the definitions/boundaries of those classifiers. For example, a new set of classifiers may include distinct, specific classes of delivery images such as “APT_LOBBY” for an apartment building lobby, “INSIDE_GARAGE” for the inside of the recipient's garage, and other classifiers as described elsewhere herein.

Because of the consistency and minimal overlap between labeled classes, the system is much more effective when finding patterns and extracting features within the images themselves. To the system, images are simply rows and columns of pixels, a.k.a. matrices.

In various embodiments, the system receives new (unseen) delivery images captured by workers and classifies them correctly applying one of a variety of labels. The images can be associated with a single delivery address or with multiple delivery addresses. Further, the images can be received from the user device of a single worker or the user devices of multiple workers. The system can then automatically scan each of the package delivery images and determine, based on the scanned images, a feature of each of the plurality of images. Based on the determined feature, the system can automatically determine a classifier for each of the plurality of images according to a classifier database. In various embodiments, the system can further associate the classifier with the delivery image. The system can further receive a request from a user device, such as a package recipient, for a virtual proof of delivery of the physical package, wherein the request includes a code. The system can then retrieve, based on the code, the classifier associated with the delivery image and send the classifier and/or the associated image to the user device. The code explicitly or implicitly includes information sufficient to identify the user, such as the user's address and/or name.

Through all of the above, and as described herein, the presently disclosed system, device and method provide a technical solution to the challenge of automated proof of delivery image processing.

### BRIEF DESCRIPTION OF THE DRAWINGS

FIG. 1 is a schematic diagram illustrating a controller and device interaction according to embodiments of the present disclosure.

FIGS. 2 and 3 are flow diagrams illustrating processes in accordance with embodiments of the present disclosure.

### DETAILED DESCRIPTION OF EMBODIMENTS

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

It will be appreciated that reference to “a”, “an” or other indefinite article in the present disclosure encompasses one or more than one of the described element. Thus, for example, reference to a device may encompass one or more devices, reference to an image may encompass one or more images, and so forth.

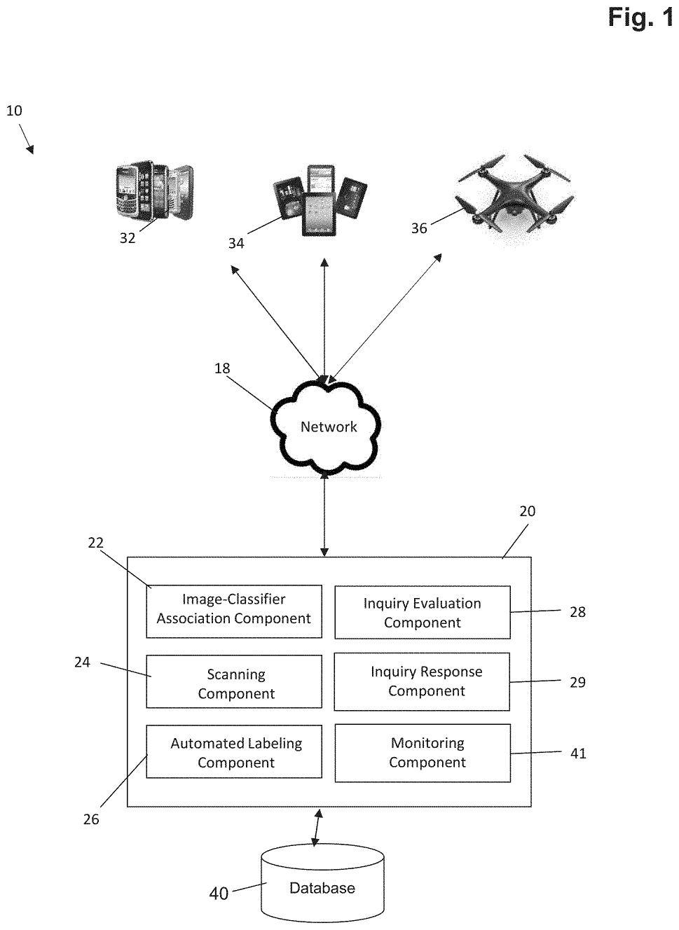

As shown in FIG. 1, embodiments of the system 10 can include a central controller 20 that provides programming for the analysis, scanning, labeling, associating and other functions of proof-of-delivery (POD) image data, either automatically or with user evaluation and input. The central controller 20 can operate with various software programming such as an image-classifier association component 22, a scanning component 24, an automated labeling component 26, an inquiry evaluation component 28 and an inquiry response component 29. The image-classifier association component 22 associates different images and image types with classifiers. In various embodiments, classifiers are provided in a database such as database 40 and can be identified as exemplified by Table 3 below.

TABLE 3

| Number | Label |
|---|---|
| 1 | APT_BREEZEWAY |
| 2 | APT_HALLWAY_AT_DOOR |
| 3 | APT_HALLWAY_POOR_LOCATION |
| 4 | APT_LEASING_OFFICE |
| 5 | APT_LOBBY |
| 6 | APT_LOCKER |
| 7 | APT_MAILBOX |
| 8 | APT_MAILROOM_SHELF |
| 9 | APT_OUTSIDE_BUILDING |
| 10 | COMMERCIAL |
| 11 | COMMERCIAL_SHIPPING_DOCK |
| 12 | WORKER_HOLDING_PACKAGE |
| 13 | INSIDE_GARAGE |
| 14 | LABEL_IDENTIFIABLE |
| 15 | MAILBOX_DELIVERY_BIN |
| 16 | MAILBOX_NO_PKG_VISIBLE |
| 17 | MAILBOX_PACKAGE_INSIDE |
| 18 | MAILBOX_PKG_AT_OR_NEAR |
| 19 | NEAR_FRONT_DOOR |
| 20 | OUTSIDE_FENCE_OR_GATE |
| 21 | OUTSIDE_GARAGE |
| 22 | OUTSIDE_ON_LEDGE |
| 23 | OUTSIDE_ON_STAIRCASE |
| 24 | PACKAGE_IN_DRIVEWAY |
| 25 | PACKAGE_IN_YARD |
| 26 | PACKAGE_ON_OR_NEAR_TRASH_CAN |
| 27 | PERSON |
| 28 | PHOTO_TAKEN_FROM_INSIDE_CAR |
| 29 | POOR_PHOTO_QUALITY |
| 30 | SIDEWALK_WALKWAY |
| 31 | TOO_CLOSE |

The scanning component 24 scans images received from one or more of various devices (e.g., camera-enabled phones 32, camera-enabled tablet devices 34, camera-enabled drone delivery devices 36). These devices are on-location at a delivery address and may be carried and operated by a worker or may be carried and operated remotely by an automated device such as a drone device 36. The image-classifier association component 22 associates an appropriate image classifier with each scanned image based on details from the scan and available image classifiers. In various embodiments, the scanning component 24 is an image recognition tool or computing device which can identify and extract specific image data as it looks for certain items such as mailboxes, porches, yards, etc. In embodiments, the scanning component 24 is configured to scan the images and generate image meta-tags for data obtained from each scanned image. The scanning component 24 can use algorithms for identifying keywords using semantic rules and image related identity markers through image recognition, for example, where the keywords pertain to items in the images that are used in classifying the image as described elsewhere herein.

The automated labeling component 26 receives the appropriate image classifier from the image-classifier association component 22 and labels each image. For example, the labeling component 26 can store the classifier and image in a database 40 of received images. The inquiry evaluation component 28 receives inquiries about stored images and classifiers in the database 40 and the inquiry response component 30 responds to such inquiries. For example, a user of a computing device (e.g., 34) may inquire as to whether a package has been delivered to the user's address while the user has been traveling away from home. The inquiry evaluation component 28 may determine, for example, if the user's request is sufficiently acceptable in order to process the inquiry. For example, the inquiry evaluation component 28 may determine if the user has sufficient credentials to receive an answer to his/her inquiry. In various embodiments, the user may provide a code or username and password, subject to potential multiple authentications in order to confirm with the system that the user is entitled to the requested information. In an exemplary embodiment where a request is received from a user device of an individual who has received a package (i.e., a package recipient) the request includes a code. The code explicitly or implicitly includes information sufficient to identify the user, such as the user's address and/or name. The system can then retrieve, based on the code, the classifier associated with the delivery image and send the classifier and/or the associated image to the user device.

Assuming the user is authenticated, the system can answer the inquiry. In various embodiments, the system returns the POD photograph and/or the image classifier for the POD photograph. It will be appreciated that the system can process other examples of requests and responses, such as, for example, a user who may wish to know how many deliveries were made to a front porch location, or how many deliveries were left exposed to harsher weather. Such input may contribute to improving delivery locations and/or mitigating package damage.

In various embodiments, the system receives new (unseen) delivery images captured by workers, determines one or more features of the image and classifies them correctly applying one of a variety of labels. For example, if the image includes a package next to a wide door with or without a series of windows, the image-classifier association component may determine that a feature in the image is a garage and further that the package has been left near the garage. If the image includes a package on a front entrance mat and a door shaped similarly to front doors, the image-classifier association component may determine an entrance mat feature and a front door feature, and further that the package has been left near a front door or on the front porch of a delivery location.

It will be appreciated that the received images can be associated with a single delivery address or with multiple delivery addresses. For example, a single delivery worker may deliver over one hundred packages in a day. Thus, the images from that worker's device will include images associated with multiple locations. Further, a single worker may deliver multiple packages of different sizes to a single delivery location. In such instances, there may be multiple POD photographs from that single location, particularly if the delivered packages are large enough that all of the delivered packages cannot be captured in a single image. In addition to the above, the images can be received from the user device of a single worker or the user devices of multiple workers. For example, a vendor may have a fleet of multiple vehicles and each vehicle may each have one driver and zero or more assistants or trainees. Each such individual worker may have one or more devices such as smartphones or other portable computing devices with image capture and communications capabilities.

In various embodiments, the system forwards API requests to a hosted AutoML model. The system can further correctly identify and save delivery images which would have previously been labeled as “Common Area Mismatch”, into one of the nine classes listed as 1-9 in Table 3 above.

In embodiments, the system can include a monitoring component 41 that may provide a user interface showing where cameras, drones and other devices associated with the system are activated and deployed, as well as the status of such devices, including anticipated remaining battery life (as applicable), environmental circumstances that may affect their operation (e.g., wind, temperature, structures), any malfunctions, and any devices held in reserve that may be deployed as back up devices. The monitoring component 41 may also provide a user with the ability to ground or deploy such devices (e.g., drones) or dispatch maintenance personnel to fix such devices as necessary. The monitoring component 41 may further provide a user with the ability to direct such devices (e.g., drones), such as movement closer to or further away from a POD location, zoom, recording video of the delivery and other directions.

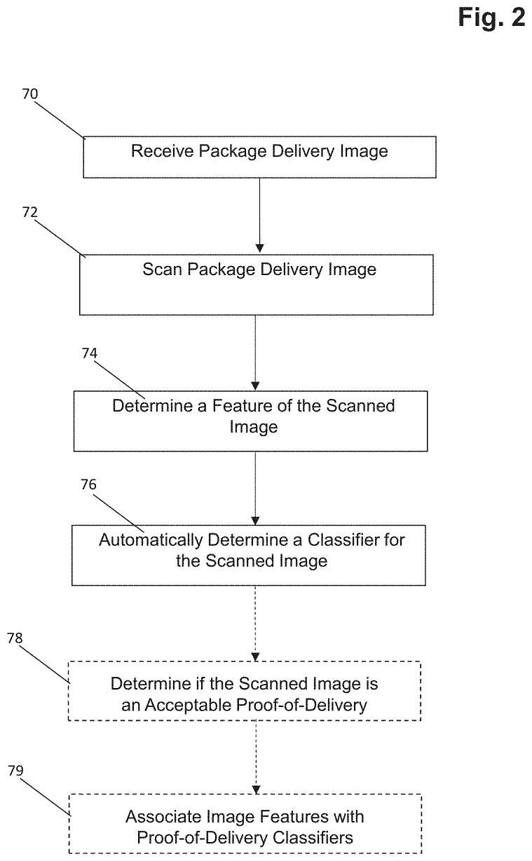

FIG. 2 illustrates an exemplary image processing flow in accordance with embodiments of the present disclosure. As shown at 70, the system receives a package delivery image uploaded from a device such as a smartphone, tablet computing device or drone delivery device, for example. As at 72, the system scans the image. As at 74, the system determines a feature of the scanned image, such as a garage door, and apartment lobby or other feature. As at step 76, the system automatically determines a classifier based on the determined feature. As at step 78, which is indicated as optional by the dashed lines, the system can determine if the image is an acceptable proof-of-delivery image based on the classifier and the scanning process. In various embodiments, the scanning component can screen each of the scanned images to determine whether inappropriate content exists. For example, images depicting vulgar wording, pet waste or other inappropriate content may be deleted. In embodiments where monitoring of incoming images is prompt, when the scanning component detects inappropriate content, a signal, message or call is delivered to the device that attempted to send in the image with inappropriate content, directing the individual operating the device to take a new photograph, move the package or take some other action to ensure another image is taken without inappropriate content. In various other embodiments, the scanning component can screen each of the scanned images to determine whether a person is present, and if so, such image can be deleted.

In some embodiments, the system can apply standards associated with the determined classifier to determine whether the image is acceptable as a good virtual proof-of-delivery image. For example, if the image is determined to be in the yard at the delivery address, the system can employ standards for yard delivery, including not on or near pet waste, not with a person in the image, not near a heating device, etc. For other classifiers, different standards may apply. For example, when a package is left in a box, there may be no need to screen for humans in the image if a human would not fit in the box. As such, the system can assist in determining and retaining acceptable/good proof-of-delivery images based on the determined classifier for the image. Returning to FIG. 2, the system can associate image features with proof-of-delivery classifiers, such as the package is “in the yard” or “by the trash can”, for example. The standards can be stored in database 40, for example. By filtering images according to classifiers and standards for acceptable images, the present system and method overcome past issues with virtual proof-of-delivery image processing and facilitate automated storage of acceptable POD images.

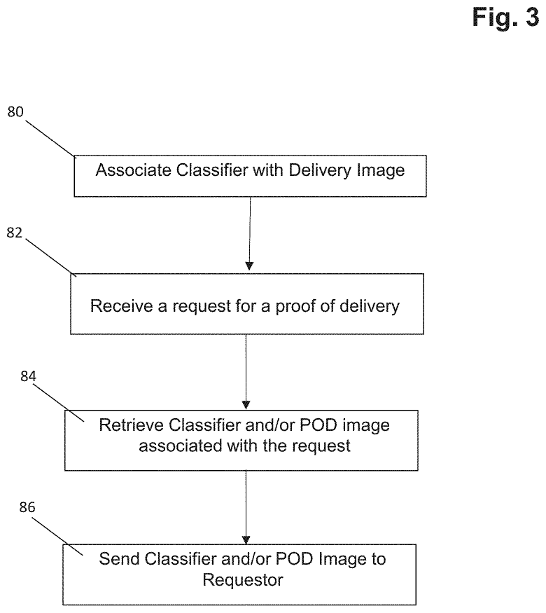

FIG. 3 illustrates an exemplary process flow of a request and response concerning proof-of-delivery (POD) images in accordance with embodiments of the present disclosure. As shown at 80, the system associates received image features with a POD classifier. As at 82, the system receives a request for a virtual POD, whether in the form of an image or a classifier for the image. As at 84, the system retrieves a classifier and/or a POD image associated with the request, and as at 86, the system sends the classifier and/or the POD image to the requestor.

It will be appreciated that the classifier can be the same for a subset of the stored images despite each image being associated with a different delivery address. Further, multiple delivery addresses can share many or all of the same features, such as a mailbox, garage, front porch, stairway, etc. The stored classifier for each image can operate as a virtual proof of delivery, and can take the form of a POD image, a classifier or some other identifier such as a code that combines aspects of the identifying information.

Unless otherwise stated, devices or components of the present disclosure that are in communication with each other do not need to be in continuous communication with each other. Further, devices or components in communication with other devices or components can communicate directly or indirectly through one or more intermediate devices, components or other intermediaries. Further, descriptions of embodiments of the present disclosure herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that, when embodied as a system, the present embodiments can incorporate necessary processing power and memory for storing data and programming that can be employed by the processor(s) to carry out the functions and communications necessary to facilitate the processes and functionalities described herein. Unless otherwise stated, devices or components of the presently disclosed embodiments that are in communication with each other do not need to be in continuous communication with each other. For example, the present disclosure can be embodied as a device incorporating a hardware and software combination implemented so as to process computer network traffic in the form of packets en route from a source computing device to a target computing device. Such device need not be in continuous communication with computing devices on the network. Further, devices or components in communication with other devices or components can communicate directly or indirectly through one or more intermediate devices, components or other intermediaries. Further, descriptions of embodiments of the present disclosure herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media.

Common forms of computer-readable media that may be used in the performance of the presently disclosed embodiments include, but are not limited to, floppy disks, flexible disks, hard disks, magnetic tape, any other magnetic medium, CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random-access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, EDGE and EVDO.

Where databases are described in the present disclosure, it will be appreciated that alternative database structures to those described, as well as other memory structures besides databases may be readily employed. The accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon. In certain embodiments, the system can employ any suitable computing device (such as a server) that includes at least one processor and at least one memory device or data storage device.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a single device or on multiple devices.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the above described embodiments are merely illustrative of numerous and varied other embodiments which may constitute applications of the principles of the presently disclosed embodiments. Such other embodiments may be readily implemented by those skilled in the art without departing from the spirit of scope of this disclosure.

1. An automated delivery image labeling system, comprising:
a processor and a memory storing instructions that, when executed by the processor, cause the processor to perform operations comprising:
receiving a plurality of package delivery images from a plurality of worker devices, wherein the images comprise images from a plurality of physical delivery addresses;
automatically scanning each of the plurality of package delivery images;
determining, based on the scanned images, a feature of each of the plurality of images; and
based on the determined feature, automatically determining a classifier for each of the plurality of images according to a classifier database.

2. The system of claim 1, wherein the classifier is the same for a subset of the plurality of images despite each of the plurality of images being associated with a different delivery address.

3. The system of claim 1, wherein the delivery addresses share the feature.

4. The system of claim 1, wherein the instructions further cause the processor to store the classifier for each of the plurality of images as a virtual proof of delivery.

5. The system of claim 1, wherein the instructions further cause the processor to screen each of the scanned images to determine whether inappropriate content exists.

6. The system of claim 1, wherein the instructions further cause the processor to screen each of the scanned images to determine whether a person is present.

7. The system of claim 1, wherein the classifier is different for a subset of the plurality of images despite each of the plurality of images being associated with the same delivery address.

8. The system of claim 1, wherein the instructions further cause the processor to determine, based on the determined classifier, if the scanned image is an acceptable proof-of-delivery image.

9. A method, comprising:
associating, by a delivery image labeling controller, a plurality of image features with a plurality of proof-of-delivery classifiers in a classifier database;
receiving, by a delivery image labeling controller, a package delivery image from a delivery worker device, wherein the package delivery image comprises one or more features associated with a proof-of-delivery classifier in the classifier database;
automatically scanning, by the image labeling controller, the package delivery image;
determining, based on the scanned image, a feature within the image; and
based on the determined feature, automatically determining a classifier for the image according to the classifier database.

10. The method of claim 9, further comprising storing, by the controller, the classifier for the image as a virtual proof of delivery.

11. The method of claim 9, wherein the classifier is the same for a subset of the plurality of images despite each of the plurality of images being associated with a different delivery address.

12. The method of claim 9, wherein the delivery addresses share the feature.

13. The method of claim 9, further comprising screening each of the scanned images to determine whether inappropriate content exists.

14. The method of claim 9, further comprising screening each of the scanned images to determine whether a person is present.

15. The method of claim 9, wherein the classifier is different for a subset of the plurality of images despite each of the plurality of images being associated with the same delivery address.

16. The method of claim 9, further comprising determining, based on the determined classifier, if the scanned image is an acceptable proof-of-delivery image.

17. An automated delivery image labeling system, comprising:
a processor and a memory storing instructions that, when executed by the processor, cause the processor to perform operations comprising:
receiving, from a delivery worker device, a package delivery image from a physical delivery address where a physical package has been delivered;
scanning the package delivery image to determine a feature of the physical delivery address;
based on the determined feature, determining a classifier for the package delivery image according to a classifier database;
associating the classifier with the delivery image;
receiving a request from a recipient device for a virtual proof of delivery of the physical package, wherein the request includes a code identifying the recipient;
retrieving, based on the code, the classifier associated with the delivery image; and
sending to the recipient device, in response to the request, the delivery image.

18. The system of claim 17, further comprising sending to the recipient device, in response to the request, the classifier associated with the delivery image.
